(19) United States
(12) Patent Application Publication
(10) Pub. No.: US 2002/0007322 A1
(43) Pub. Date: Jan. 17, 2002

(54) Electronic product information system

(76) Inventor: Steven R. Stromberg, Scandia, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 09/841,476

(22) Filed: Apr. 24, 2001

Related U.S. Application Data
(60) Provisional application No. 60/199,341, filed on Apr. 24, 2000.

(51) Int. Cl. G06F 17/60

(52) U.S. Cl. 705/26

(57) ABSTRACT

A system and method for providing supplemental product-specific information without interfering with the commercial transaction at the point of sale. A primary product reseller directs a consumer to the third party information system using a URL with an embedded product identifier. The information system parses the URL to extract the embedded product identifier, searches its database for the product according to the product identifier, and displays a new custom web page containing the supplemental information. Finally, the third party information system returns the consumer to the referring primary product reseller.

### CROSS-REFERENCE TO RELATED APPLICATION(S)

The present application claims priority from Provisional Application Serial No. 60/199,341, filed Apr. 24, 2000, entitled ELECTRONIC PRODUCT INFORMATION SYSTEM AND METHOD FOR RETAIL DIRECT MARKETING/CATALOG USERS: CUSTOMIZED “SEARCH ENGINE.”

### BACKGROUND OF THE INVENTION

The present invention relates to a system for providing supplemental product information to consumers over the Internet. More specifically, the present invention is a system for providing product-specific, manufacturer specifications and other technical information to the consumer upon request in order to supplement online catalog information or information presented in a printed catalog or newspaper advertising supplements.

During design and production of a product, manufacturers acquire and accumulate a great deal of information about their products. Manufacturers provide much of this information to resellers, and increasingly make such information available to consumers, as well. Resellers need this product information to select, promote and sell products they distribute. In addition, consumers often desire this information in order to make informed purchasing decisions. Advertisers, product analysts, manufacturer representatives, shippers, and many other people also need information about the product, which may not be readily available or apparent from the product packaging.

Typically, product packaging and print advertising is a primary outlet for disseminating product information. Such information is often a small sampling of available information. To the extent that the information is incorporated into the product packaging, the amount of information provided maybe limited by space considerations. In addition, such information is available only in the distribution of the product itself.

Since the 1870's when Montgomery Ward began its mail order business with the issue of its first catalog, catalog distribution has become one of the primary print media vehicles for dissemination of product information. However, product catalogs are also limited by space considerations, and the scope of the dissemination of information is limited to the catalog distribution. With the growth and increasing popularity of the Internet, many catalog distributors have begun offering their mail order services via the Internet. Despite the flexibility and possibilities afforded by the multimedia format of the Internet, catalog Internet sites tend to provide the same limited information and format as the traditional print media. Such formatting and content fails to take advantage of the potential and possibilities that the world wide web provides.

Increasingly, manufacturers are attempting to use the Internet to disseminate product specifications. By providing technical specifications and other product information on their own web sites, manufacturers provide supplemental information for consumers to educate themselves and to assist in the buying decision. However, such information is often difficult to locate, particularity when the uniform resource locator (URL) of the manufacturer's web site is not known or is different from the product name. Thus, though technical information and supplemental product information, which might assist in the consumer's buying decision, is available on the Internet, many consumers simply cannot find the information when they need it. In addition, often the information is not conveniently accessible to the consumer, because finding the information requires visiting a different web site, and locating the information within that other site.

An attempt has been made to make this information more readily accessible to a consumer by storing a table of web site addresses corresponding to universal product codes, such that consumers are redirected to a manufacturer's web site for additional product information. U.S. Pat. Nos. 6,154,738 and 5,913,210 are embodiments of such a solution. However, such systems fail to maintain control of the consumer for the product reseller.

Direct marketing/catalog, retail and business-to-business sales represent a significant percentage of commerce conducted in the world-wide market place. Despite recent development by many catalog distributors (direct marketers) of Internet sites in conducting electronic commerce, the printed catalog continues to play an important role in the overall marketing/communication of product information for creating sales through the mail order/e-commerce distribution channel. A long-time limitation of printed catalog sales has been the restricted amount of space allowed for conveying product information to prospective customers. For most products in product catalogs, fractional space page units are used, generally restricted to a product photo, limited descriptive copy, and product price. Despite the absence of space limitations on the Internet, Internet catalog sites typically do not take advantage of the opportunity to convey all of the available product information, relying instead on traditional advertising copy and print media restrictions. Typically, online catalog web sites import the same space and text limitations from the printed catalog pages.

Today's Internet infrastructure makes it possible to provide catalog customers with product information beyond the limitations of the printed page. Space and size constraints no longer limit the product copy. In addition, the world wide web supports multimedia interactions, such as sound, animations, video and the like which cannot be provided by the printed page. Nevertheless, while it is now possible for manufacturers to provide access to such product information, conflicting objectives between direct marketing catalog distributors and their respective vendors generally interfere with such exploitation of the communicative power of the Internet. Specifically, out of fear of losing control of customers or losing a customer's attention, catalog and other resellers are generally unwilling to direct a potential customer away from their own web site, or direct them at any time or under any circumstances to the manufacturer's corporate web site.

### BRIEF SUMMARY OF THE INVENTION

Within the pages of a printed catalog and its associated Internet site, selective product items offered by participating resellers are footnoted with a special graphic icon to invite customers to an independent, third-party web site to view additional product information deemed useful in making a buying decision. The link or icon contains embedded information for retrieving the specific product information. The web server displays a web page interface identifying the originating catalog and displaying the supplemental information about the product including technical information. Once the consumer is finished viewing the information over the Internet, the consumer is referred back to the reseller's site to complete the sales transaction.

### BRIEF DESCRIPTION OF THE DRAWINGS

FIG. 1 is a conceptual diagram of the product information system of the present invention.

FIG. 2 is a block diagram of the product information system of the present invention.

FIG. 3A illustrates a printed catalog page containing an icon and web site address for the information system.

FIG. 3B illustrates an on-line version of the catalog of FIG. 3A containing a clickable link to the information system.

FIG. 4 is a schematic flow diagram of a manufacturers interaction with the system of FIG. 2.

FIG. 5 is a schematic flow diagram of a catalog initiated consumer interaction with the system of FIG. 2.

FIG. 6 is a schematic flow diagram of a direct interaction of a consumer with the system of FIG. 1.

FIG. 7 is a schematic flow diagram of a consumer's interaction with a cross-marketing interface for the system of the present invention.

### DETAILED DESCRIPTION

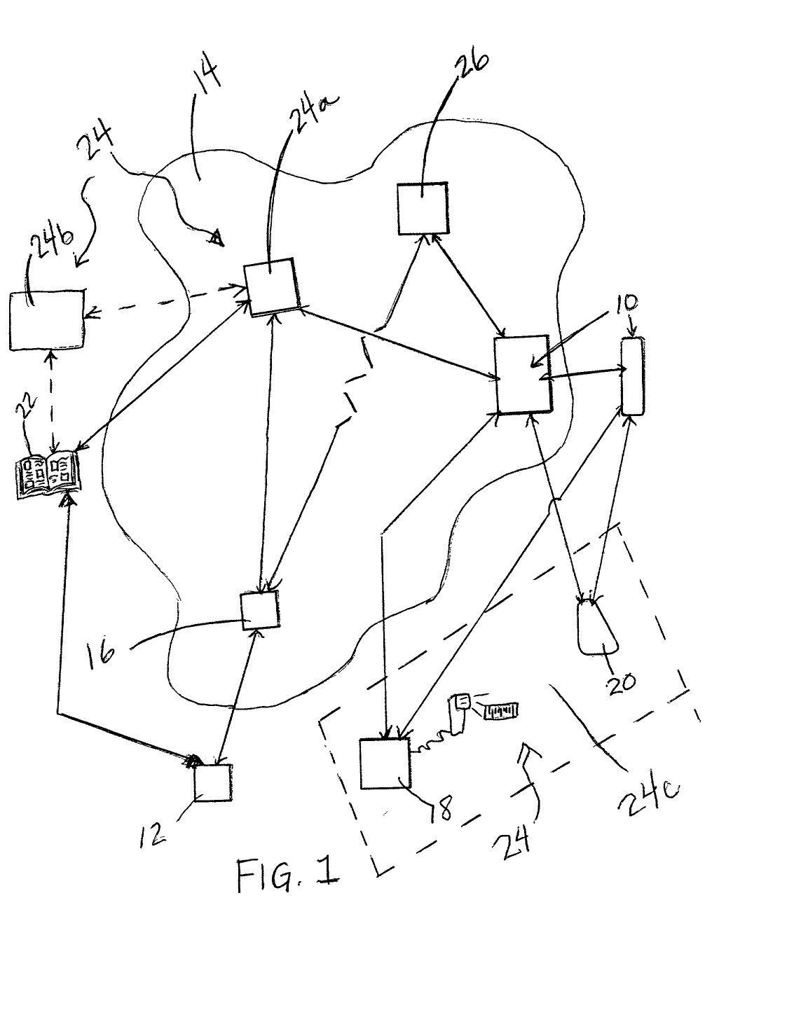

FIG. 1 provides a conceptual overview of the product information system 10. A consumer 12 interacts over the Internet 14 with the product information system 10 to view supplemental product information, using a computer 16, a bar code scanner 18, a kiosk 20 located in a retail store, or other communication devices, such as a personal digital assistant (PDA), and the like. Other communication means may also be used, such a digital phone via a wireless application protocol server (not shown) and the like. The bar code scanner 18 and kiosk 20 can also be configured to interact directly with the product information system 10.

A consumer 12 views product information in a printed catalog 22 provided by a product reseller 24. To learn about the product, the consumer 12 can visit a web site of the product reseller 24 over the Internet 14. However, to view supplemental product information, the consumer 12 may have to search the Internet 14, visit a web site of the manufacturer 26 over the Internet 14, or visit a different reseller's web site (not shown). Generally, product resellers 24 do not want to lose the attention of the consumer 12 or direct a potential sale to a competitor. Thus, the product reseller 24 directs the consumer to the product information system 10 for supplemental information, thereby bypassing the manufacturer's web site and placing the product-specific information at the fingertips of the consumer 12. The broken line in FIG. 1 illustrates that the connection that the reseller 24 does not want to encourage between the consumer 12 on his or her computer 16 and the manufacturer 26. Without the product information system 10, consumers 12 are encouraged to search for supplemental product-specific information, and may ultimately purchase a product from some other seller. Thus, the product information system 10 makes the product-specific information readily available to the consumer 12, without losing control or losing the attention of the consumer 12.

Generally, the product reseller 24 may sell products via any number of commercial channels, including the printed catalog 22, an on-line web site, a building or store, and so on. The various elements shown in FIG. 1 are intended to present some of the different ways that consumers 12 may interact with the product information system 10, as well as the positioning of the product information system 10 as a third-party to the interaction between a consumer 12 and a product reseller 24.

As shown in FIG. 1, a reseller 24 may have an on-line web site presence 24a, a catalog 22 provided by a catalog reseller 24b, a bar-code scanner 18 and/or a kiosk 20 inside a store provided by reseller 24c. The business operations of a single reseller 24 may include a store 24c, a web site 24b, and a catalog operation 24a with its catalog 22.

Using the product information system 10, the printed catalog 22 contains information urging viewers to visit the product information system 10, by displaying a web site address for the product information system 10 next to products offered in the catalog 22. Thus, consumers 12 are invited to visit the product information system 10 directly using a computer 16 or any other means. Once the information is displayed for the consumer 12, the consumer 12 is directed back to the referring reseller's web site 24a to complete a sale.

The product information system 10 acts as a third-party to the interaction of consumers 12 and resellers 24 or manufacturers or vendors 26. Resellers 24 generally include catalog retailers, wholesalers, or any merchant who sells a product. Resellers 24 refer consumers 12 to the product information system 10 for supplemental product information to assist the consumer 12 in making a purchasing decision. The product information system 10 displays the requested information and returns the consumer 12 to the referring retailer 24a to complete the sale. Thus, the product information system 10 exists as a third-party to the purchase transaction, but does not cause the reseller 24 to lose control over the consumer 12 or to lose the consumer's attention.

Store resellers 24c may install kiosks 20 or bar code scanning terminals 18 on the sales floor which allow consumers 12 to scan a product to retrieve supplemental product information from the information system 10, either directly via telephone or dedicated connection or indirectly via an Internet connection. Retailers can use kiosks 20, bar code scanners 18, keyboards and computer terminals 16 to retrieve supplemental product information to assist consumers 12 who require additional technical or general sales information before making a buying decision. Consumers 12 exploring retail shelves often find it difficult to get help from retail store clerks. Placing computer kiosks 20 or bar code scanners 18 with computer screens strategically within a retail store environment would permit consumers 12 to either bar code scan a product or type in the sku number via a direct link to the product information system 10. Thus, access to the product information system 10 is not only valuable to the catalog companies, but also to retail store clerks, because it enhances their ability to detail a product for the benefit of the consumer 22, and ultimately for the benefit of the vendor 26.

Retail stores can program a computer terminal 16 to link to other possible sources of information, additional to the product information system 10, such as inventory availability, in-store coupons, manufacturer rebate programs, and the like. In a preferred embodiment, linking of retail stores to the supplemental product information system 10 occurs through a customized database designed for point of purchase (POP) retail use only.

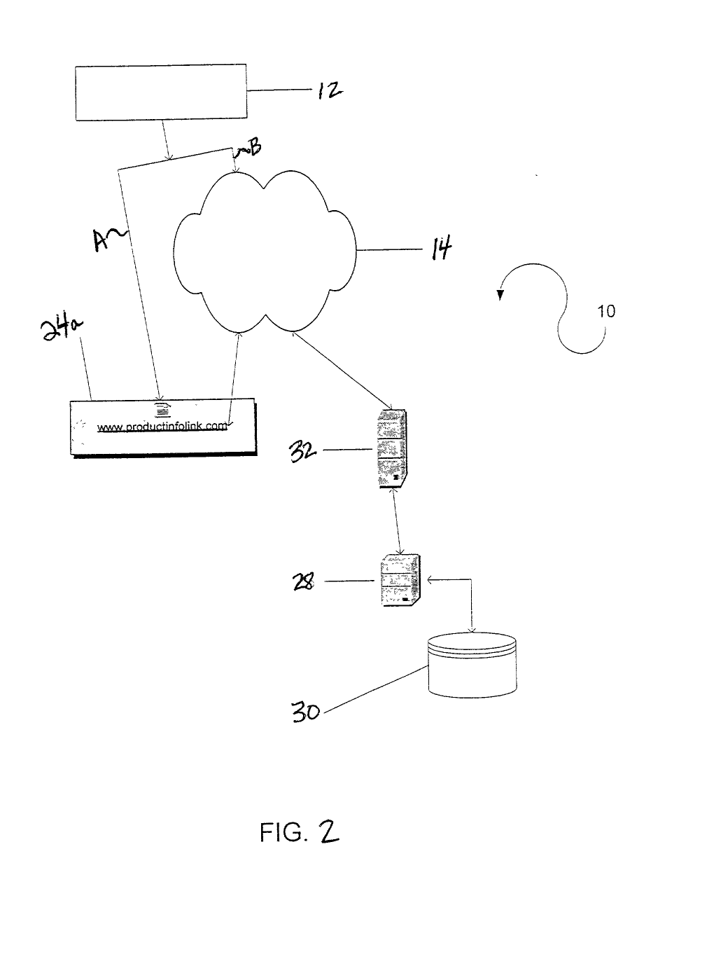

As shown in FIG. 2, the product information system includes a web server 28 and a database server 30 that are connected to the Internet 14 through a firewall 32. Consumers 12 can interact with the web site interface provided by web server 28 either directly through the Internet 14 or indirectly through a reseller's web site interface 24a, which contains a link or button to the product information system 10. Essentially, the product information system 10 is a third-party to the interaction between a consumer 12 and a product reseller 24a. The product information system 10 provides product-specific supplemental product information to the consumer 12 at the point of sale to assist the consumer 12 in making a buying decision, without diverting the consumer 12 away from the reseller web site 24a.

Generally, if the system 10 is hosted by a third party Internet service provider, the firewall 32 will be provided by the Internet service provider. If the system 10 is its own Internet service provider, the firewall 32 is part of the product information system 10.

The firewall 32 protects the web server 28 and its database 30 from unauthorized access. The manufacturer 26 can build the content by inputting product-specific information into the database 30 through the web server 28 by logging onto the web server 28 through the firewall 32. Generally, access to supplemental product information stored in the database 30 does not require a password, but the database 30 does not permit changes to information except through authenticated, secure transactions. Ordinary access privileges do not include authority to alter the data records. Thus, consumers 12 who access the product information system 10 via the Internet 14 are provided “guest access” to view the specific product information.

The configuration of the product information system 10 permits consumers 12 to access supplemental product-specific information over the Internet 14. The supplemental product information is stored in database 30, and the consumer 12 accesses the information over the Internet 14 either from the reseller's on-line web site 24a (option A) containing a clickable link to the product information system 10, or by typing in a web site address or URL and visiting the product information system 10 directly (option B).

Participating vendors 26 sign up with the product information system 10 to assist in marketing their products. Vendors 26 pay for the service for each product and expect their resellers 24 to include a link to the product information system 10 from their catalog web site 24a, printed catalogs 22, printed circulars, and the like. Thus, the catalog web site 24a, printed catalogs 22 and newspaper circulars direct potential consumers 12 to the product information system 10 for additional product information, such as technical specifications and other information compiled and provided by the vendor 26.

Generally, vendors 26 accumulate information about their products during the production process. Technical specifications combined with production information provides often-needed supplemental information designed to assist consumers 12 in making buying decisions. The product information system 10 is designed to host the supplemental product information and to place the supplemental product information at the consumer's fingertips, making the information quickly and conveniently available upon request.

The product information system 10 does not interfere with purchase transactions, but instead refers the consumer 12 back to the referring site 24a for the consumer 12 to complete the transaction decision. Catalog and retail merchants 24, the vendor 26 and any other reseller 24 of the product can safely refer the consumer 12 to the product information system 10 for additional information without fear of losing the sale or of losing control over the consumer 12. If the consumer 12 is referred by a reseller's web site 24a, the consumer 12 is referred back to the referring web site 24a. If the consumer 12 is referred to the product information system 10 via an advertisement in a printed catalog 22, the product information system 10 will display the product-specific information and refer the cnosumer 12 back to the catalog reseller's on-line web site 24a.

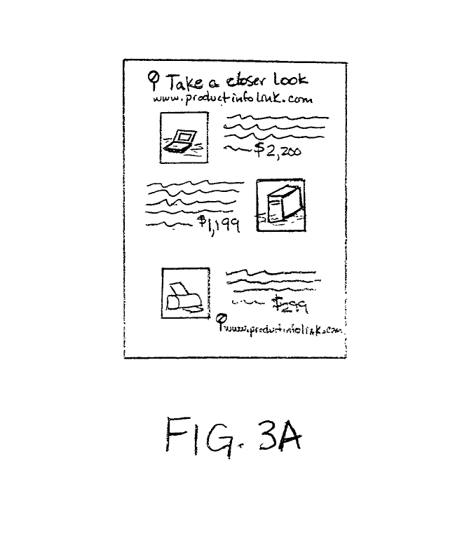

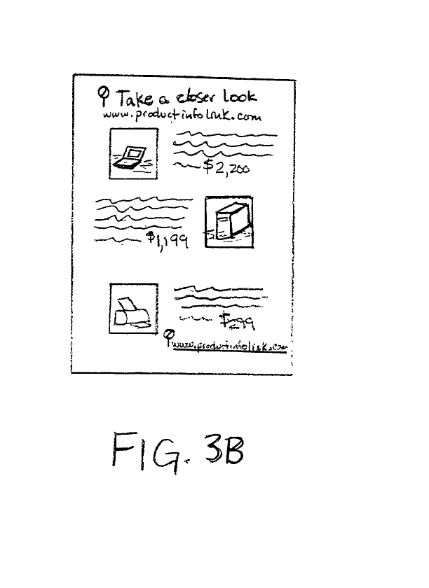

Participating vendors 26 who wish to utilize the supplemental product information of the product information system 10 expect the catalog company to include a hypertext link or icon on the catalog company Internet site linking to the product information system 10. In addition, the hypertext link to the product information system 10 is promoted in the printed catalog 22 (as shown in FIG. 3A) so that consumers 12 who are perusing a product catalog can learn how to conveniently access supplemental product information over the Internet 14. The printed catalog or newspaper circular promotes a URL to link the consumer 12 directly with the product information system 10.

The web server 28 may be any server capable of connecting with the Internet 14 and with the database 30 and dynamically displaying information to a remote user. The data base 30 may be in any data base format, including relational, flat file, and the like, and may be written in any computer software language. The only limitations on the structure of database 30 is that the database 30 must be written so as to be web-enabled such that a web site interface maybe used to access the data and must be capable of permitting storage and retrieval of text, graphical information, and other multimedia file types including sound, video and the like. The database 30 provides a vehicle for disseminating product information which exceeds the capabilities and limitations of the printed page.

As shown in FIG. 3A, a printed catalog contains a graphic icon adjacent to a particular product to invite the consumer to visit the product information system 10 to view supplemental product information. As shown in FIG. 3B, the on-line version of the same catalog contains a clickable icon or hypertext link, which links the consumer directly to the product information system over the Internet.

Within the pages of the printed catalog or newspaper circular or other print advertisement, selective product items produced by participating vendors 26 are footnoted with a special graphic icon to invite consumers 12 to an independent, proprietary web site to view additional product information deemed useful in making a buy decision. Each printed catalog page or circular includes a notice of the Internet product information system 10 with this special icon or logo next to each participating item number. For example, the icon could be a magnifying glass with a caption “want to take a closer look? http://www.productinfolink.com.”

Though vendors 26 accumulate product information and often include the product information in web site content on their Internet web sites, typically catalog resellers 24 do not display web addresses for the vendors 26 next to the product listing. Instead, the web site developer, advertising agency or someone at the offices of the reseller 24 makes a decision about what information should be communicated to the potential buyer to aid in making the buying decision. Since most web sites and print advertising have space limitations, much useful information is often discarded as being irrelevant to the buying decision.

At the time of the buying decision, though useful product information may be available, the product information is not made accessible by the reseller 24 for the consumer's benefit. While the reseller 24 could direct the consumer 12 to the web site of the vendor 26 for additional information, resellers 24 are understandably reluctant to do so. Generally, inserting such a link into the catalog web page diverts the consumer 12 away from the reseller 24. Resellers 24 do not want to lose control over a customer or lose the customer's attention. Worse yet, resellers 24 do not want to lose a potential sale to a competitor. Manufacturer web sites could potentially lead consumers 12 to competitors or even invite direct sales by the vendor 26 to the consumer 12, thereby interfering with the reseller's business.

The http://www.productinfolink.com link of the present invention is designed to open a new browser window and direct the consumer 12 directly to a supplemental description of the selected product. The supplemental information is provided from the database 30 through the web server 28 into the newly opened web page. The consumer 12 is permitted to browse the information provided, and then close the window. No other options are made available to the consumer 12 so the consumer 12 must close the new browser window in order to view the resellers web page. In the preferred embodiment, the clickable link does not open a new browser window, and ultimately directs the consumer 12 back to the ordering page of the referring reseller 24a to complete the sale.

Product brochures, technical specifications, accumulated test data, comparison charts and numerous other standard informational items provide expanded content that may assist consumers 12 in making buying decisions. The product information system 10 places this information at the consumer's fingertips, just one click away from the point of sale. Thus, the information is provided to the consumer 12 at the time of the buying decision, the most critical time for closing the sale.

The records in the database 30 reflect information content provided by the vendor 26. Technical information, graphics, schematics, video, sound, and text may be incorporated to provide a flexible supplemental product overview, which does not have the space and format limitations of the printed page. The multimedia capabilities of the Internet impose no space and format constraints on the site's content. The supplemental product information can include video and sound, which cannot be communicated by the printed page. Thus, a vendor 26 can provide a video clip of a product demonstration to supplement the product information content, and the system 10 can stream the video upon request so that a consumer 12 can supplement his or her understanding of the product.

Within the database 30, the product information for each product is identified within the database 30 by its manufacturer product number or catalog reseller 24 assigned item identifier unique to a specific product, such as an item number, a sku number, and the like. For some small vendors 26, who do not yet assign product numbers to each product, the system 10 provides a custom product number for use in the newspaper circulars or other advertising copy so that the product may be easily retrieved for the consumer 12. The information may be retrieved using any unique product identifier.

In addition to product information stored in the database 30, information about the various online catalog companies or resellers 24 may be stored in the database 30. Each referring catalog site 24a is a referral source, and links from a catalog site 24a to the product information system 10 included embedded catalog identifiers which are used to retrieve and display an indication of the referral source. The web server 28 retrieves both the referral source information and the product information, and displays the product information within a new customized web page so as to associate the product information with the referring reseller's web site 24a. In other words, the new web page contains a heading identifying the reseller using a logo or a dynamic text heading and the supplemental product information. If the catalog company wishes to license the use of its logo within the display page, the logo will be used. Otherwise, the header is built dynamically by the web server 28 so that the header displays the source of the referral.

Though FIG. 2 shows the system 10 of the present invention with respect to a single database 30 and a single web server 28, multiple databases 14 and web servers 12 may be connected as the back end to the system 10, provided the search engine is configured to scan multiple databases 14.

Before the database 30 may be used by the web server 28, information about the various product offerings must be stored in the database 30. The information may be gathered and written by the vendor 26, by the host of the product information system 10, by a third party advertising agency, or any other number of companies or services. In one embodiment, the vendor 26 gathers the product information and technical specifications and transmits that information to the host of the product information system 10, who then edits and organizes the information into a coherent and appealing informational layout of the product. In the preferred embodiment, the vendor 26 produces and edits the supplemental information by visiting the product information system 10 and inputting the product information directly into a template. The system 10 uses the template to format the customized product information layout, such that the vendor 26 can select the look and feel of the display pages.

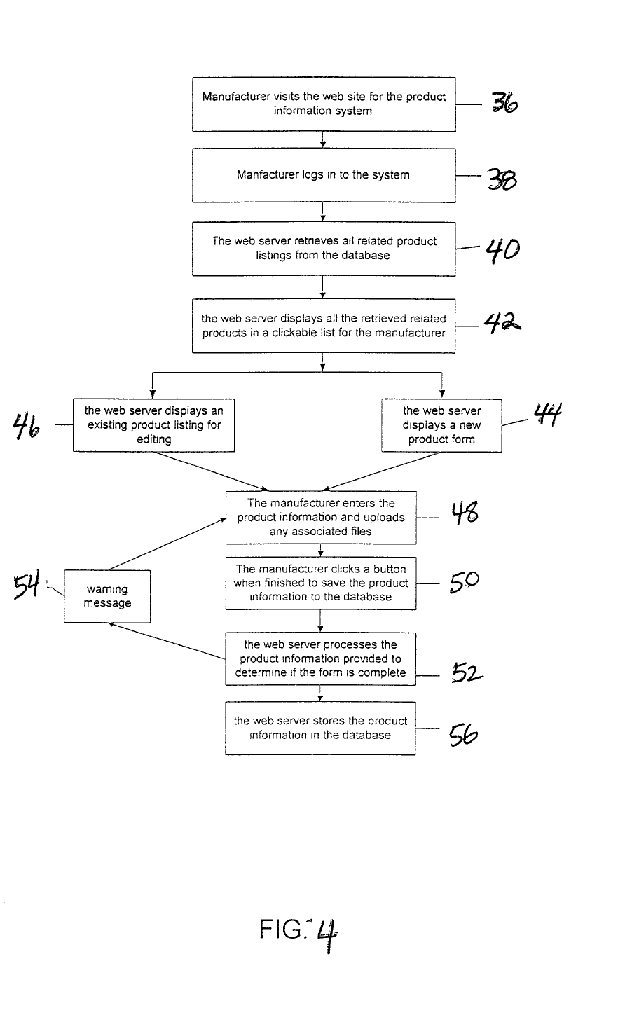

As shown in FIG. 4, the vendor 26 visits the web site for the product information system 10 over the Internet 14 (step 36). The product information system 10 displays a web page for the vendor 26 to sign on to web server 28, and the vendor 26 logs into the system 10 (step 38). The web server 28 verifies the user name and password of the vendor 26, and, after authenticating the user, retrieves all related product listings from the database 30 according to the vendor 26 (step 40). The web server 28 then displays all of the retrieved related products in a clickable list for the vendor 26 (step 42). In the preferred embodiment, the list is displayed in chronological order such that the oldest items appear at the top of the list. Requiring the vendor 26 to sift through older items prior to find the product he or she wishes to amend helps each vendor 26 to identify and remove items that are no longer featured in a catalog or newspaper circular.

The list of products may be edited, products may be deleted, and new products may be added. The vendor 26 clicks on a button on the page with the clickable list for generating a new product. If the vendor 26 clicks the “new item” button, the web server 28 displays a new product form or template for the vendor 26 to edit. (step 44). If the vendor 26 clicks on a product in the clickable list, the web server 28 retrieves the product information from its database 30 and displays it for the vendor 26 (step 46).

The vendor 26 then enters the product information and/or edits the existing product information and uploads any associated files such as pictures in standard Internet 14 formats, sound files, video streams, and the like (step 48). Once the vendor 26 has finished editing or inserting new information, the vendor 26 clicks a button to save the product information to the database 30 (step 50). The web server 28 processes the product information provided to determine if the form is complete (step 52). If the form is incomplete (such as the manufacturer number is missing), the web server 28 displays a warning message (step 54) and returns the vendor 26 to the web form to complete the product information (step 48).

Once the web server 28 has processed the information (step 52) and determined that the form is complete, the web server 28 stores the product information in the database 30 (step 56). Then the vendor 26 is returned to the list of related product listing from the database 30 (steps 40 and 42).

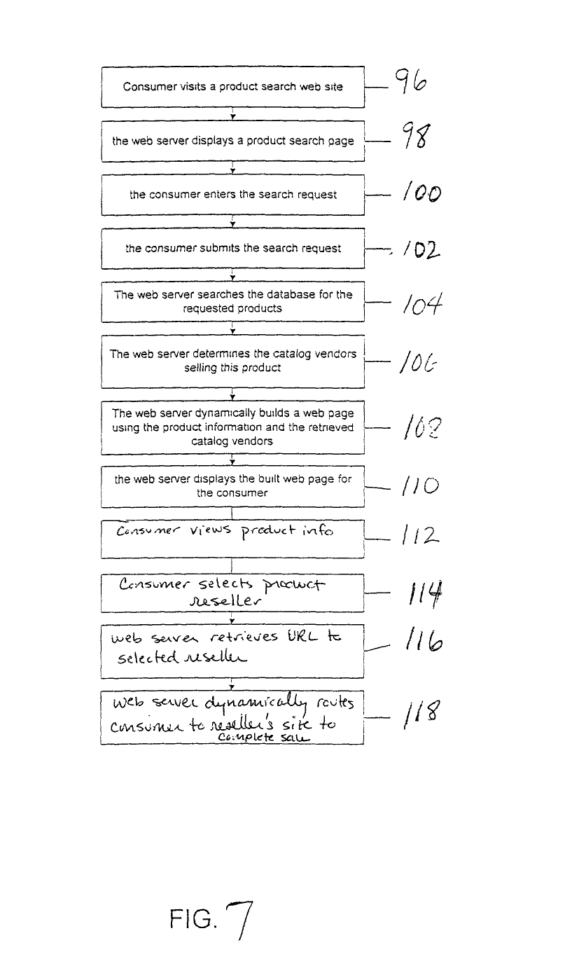

Once the product information is stored in the database 30, the product information is immediately available for retrieval via the web site interface. The information may be retrieved through a referral link with embedded information, a referral link to a front page retrieval form, a direct link over the Internet 14, or through a cross-marketing interface (as discussed with respect to FIG. 7).

For participating vendors 26, the on-line catalog displays a small icon or hypertext link on each web site page, which links to the product information system 10. Additionally, on-line catalog resellers 24a place a link or clickable icon next to specific products for participating vendors 26, linking the specific product to the product information system 10. Additionally, print advertising promotes the URL or web site address for the product information system 10, thereby encouraging consumers to visit the system 10 for additional product information.

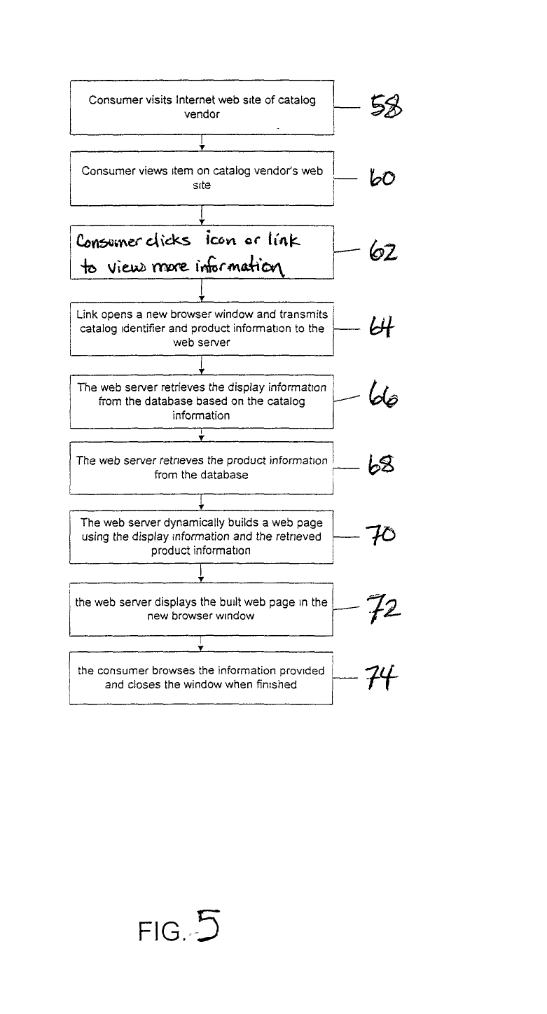

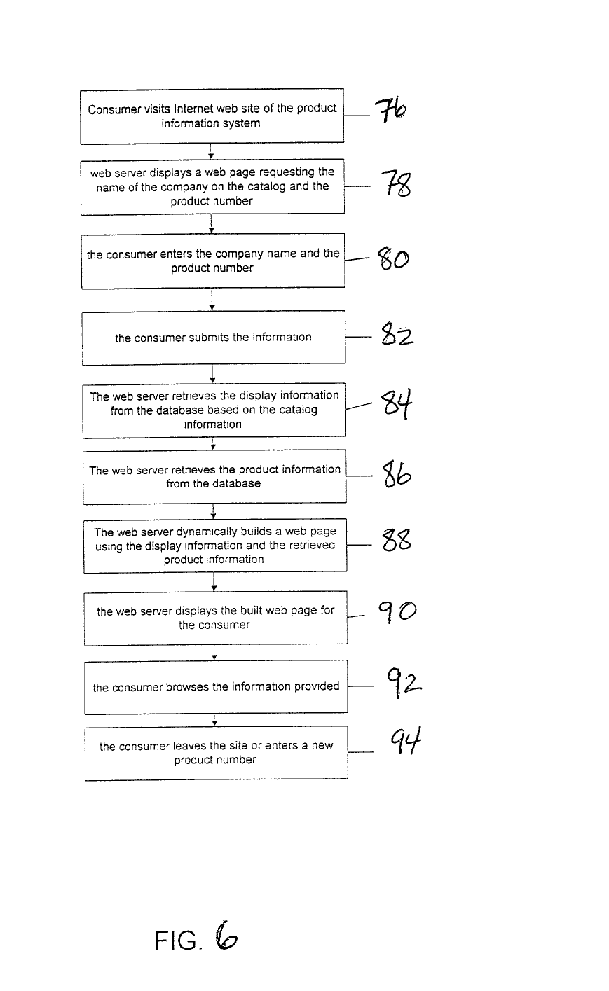

As shown in FIG. 5, the consumer 12 is directed to the product information system 10 for supplemental product information from an on-line catalog reseller web site 24a. The reseller 24 uses an on-line web site 24a to conduct product sales. Consumers 12 visit the web site 24a of the reseller 24 and searches for products. If the consumer 12 wants to see additional information, the consumer 12 clicks on the link, which directs the consumer 12 to the product information system 10. In addition to linking directly from the on-line web site 24a of the reseller 24, consumers 12 may interact with the product information system 10 directly (as shown in FIG. 6). FIG. 5 illustrates the interaction of the consumer with the product information system 10, when the consumer is referred by a link or an icon with embedded information from an on-line web site 24a of a reseller 24.

When a consumer 12 visits the web site 24a of an on-line reseller 24 (step 58), they browse items for sale (step 60). If the consumer 12 wishes to see more information about a particular product, the consumer 12 clicks on a link or button to view more information about the item (step 62). The button contains embedded information, including the manufacturer product number or sku number and a referring catalog identifier.

The product information system 10 is customizable to provide the catalog brand information in the product information window for participating on-line catalog resellers 24. An on-line catalog reseller 24a who wishes to have its trademark displayed by the product information system 10 in conjunction with referred consumers 12 can license the use of its mark for the limited purpose of displaying a customized product information page. Otherwise, the product information system 10 displays a dynamic header, which includes a statement indicating the referral source. The limited use of the catalog reseller's mark is intended to provide a customized product information page having the images of the reseller 24 so that the product information system 10 provides the information in an interface that shares the look and feel of the reseller 24. Thus, the retrieval of the supplemental product information maintains a continuity with the referring site 24a, so that the retrieval and display of the information is seamless for the consumer 12.

Clicking on the button to view more information causes the browser to open a new browser window and transmit source identifier and product information to the web server 28 (step 64). The web server 28 retrieves display information from the database 30 based on the catalog information (step 66). The display information includes image data and other information about the reseller 24, which allows the product information system 10 to build a hypertext page that looks and feels like the web page of the reseller 24, thereby making it seem to the consumer 12 as though the consumer 12 never left the reseller's web site.

Then the web server 28 retrieves the product information from the database 30 (step 68). The web server 28 dynamically builds a web page using the display information and the retrieved product information (step 70) and displays the web page in the new browser window (step 72). The consumer 12 then is able to browse the information provided and close the window when finished (step 74). Closing the window causes the consumer to be returned to the web site of the on-line reseller 24 to complete the sale.

The example described above anticipates opening of a new browser window upon clicking on the link to the product information system, thereby preventing the consumer 12 from being directed away from the site 24a. In the preferred embodiment, browser plugins and/or the web server 28 controls the activity of the consumer 12, such that the consumer 12 is referred back to the referring reseller's web site 24a to complete the sale.

Though the link to the product information system 10 was described as a button, the link may also be a hypertext link, a clickable image or icon, or any other user initiated means. In the preferred embodiment, the clickable link is an icon and text indicating “more information.”

If the on-line catalog reseller 24a wishes to affiliate with the product information system 10, the catalog provider may invite consumers 12 to enter their email address in the new built window and submit the email address if they are interested in receiving notices about sales and offers from that catalog reseller 24a. The system 10 provides a permission-based e-mail solicitation feature that may be initiated and controlled by the reseller 24a. The product information system 10 of the present invention monitors price changes with the on-line catalog company 24a, and also permits the catalog company 24a to provide notices to the product information system 10 about sales and other special offers which may then be transmitted to the email list. The list of email addresses is stored in the database 30 for later retrieval. In addition, the list may be transferred to the on-line catalog company 24a in digital or paper form, to assist the retailer 24a in building and maintaining an customer e-mail list.

As shown in FIG. 6, consumers 12 may visit the product information system 10 directly, using a web site address promoted in a printed catalog 22 or newspaper circular. The consumer 12 is required to enter the name of the printed catalog 22 or circular company and the product number so as to retrieve the product information and a link to the referring source to complete the sale. FIG. 6 illustrates the interaction of consumer 12 with the product information system 10 when the consumer 12 is referred to the system 10 by a printed catalog 22.

Other options are also available. For example, a link is offered from the Internet web site interface of the product information system 10, which allows vendors 26 to visit the web site and log into, enter new information or update information within the database 30 about their product offerings. (as discussed with respect to FIG. 4). In addition, catalog companies who partner directly with the product information system 10 can provide supplemental information and/or special pricing information to the product information system 10 directly.

Since direct access is not provided from a link, a web site interface is provided for the consumer 12 to enter the catalog name and product number. Since many people enjoy browsing printed catalogs, some consumers 12 may be looking at the printed catalog 22 or newspaper circular and desire to see more information about a product. Participating catalog or retail resellers 24 include a web site address to the product information system 10 next to specific products inside the printed advertising copy. A consumer 12 visits the web site address of the product information system 10 by typing in the URL (step 76).

The product information system 10 displays an Internet web site interface, which provides information about the services offered by the product information system 10. Individuals who are interested in learning more about the product information system 10 click on a link and are given information about the system 10. Consumers 12 who are interested in viewing more information about a specific product in a catalog, are required to enter the catalog name and product number (step 78). The consumer 12 enters the requested information (step 80) and submits the requested information (step 82).

Once the consumer 12 has submitted the requested information (step 82), the web server 28 retrieves the display information from the database 30 based on the catalog information provided (step 84). The web server 28 then retrieves the product information from the database 30 (step 86). The web server 28 dynamically builds a web page using the display information and the retrieved product information (step 88). The dynamically built web page includes a link to the web site of the participating catalog reseller 24, so that the consumer 12 can click on a link to place the order. Then, the web server 28 displays the built web page for the consumer 12 (step 90). The consumer 12 browses the information provided (step 92), and then the consumer 12 may either close the window, enter a new product number to search, enter their email address as previously described, or leave the site entirely (step 94).

The product information system 10 does not complete the commercial transaction, but rather provides supplemental information to consumers 12 to assist in the purchase decision. Thus, the consumer 12 is referred back to the reseller's web site 24a to complete the transaction.

Alternatively, rather than asking the consumer 12 to type in the catalog information, the various catalogs companies 24b may be listed in a pop-up list so that the consumer 12 simply selects the catalog from the pop up list. Products shown in printed catalogs 22 not listed may be retrieved using the manufacturer's name, thereby allowing the vendor 26 to supplement product information for all of its products. As with the catalog reseller 24, vendors 26 can refer consumers 12 to the product information system 10 for supplemental product information, instead of maintaining the information in multiple on-line web sites and instead of cluttering their own web site with the information. Thus, the product information system 10 serves both resellers 24 and vendors 26 by hosting the supplemental information, displaying the information upon request, and returning the consumer 12 to the referring site to complete the product sale.

In the preferred embodiment, the clickable link contained in the printed catalog 22 contains a path such that typing in the URL or web site address of the product information system 10 as provided, completes the catalog brand name entry so that the consumer 12 need only fill in the product item number. In other words, the printed catalog 22 may provide a web site address such as the following: “http://www.productinfolink.com/catalogname/”. By typing in the given URL, the consumer 12 is directed to a page to enter the product item number, thereby bypassing the ordinary user interface and proceeding directly to the product information.

The product search page includes both the reseller identifier and the product identifier. The consumer 12 is required to enter both pieces of information for the search to proceed. Failure to provide the reseller identifier (i.e. the catalog company's name, the manufacturer's name, the name of the reseller 24, and the like) results in an error message. In the preferred embodiment, the reseller identifier is selected from a list in order to minimize typographical errors and search variations. The list may be a pop up list, a pull down menu, or any other similar list option for the consumer 12 to select the name of the reseller 24.

It is possible to offer cross-marketing opportunities for vendors 26 and catalog resellers 24 who are interested in using the product information system 10 to market their product offerings. Specifically, the product information system 10 offers a web page interface that is unrelated to the consumer page previously described. Consumers 12 are attracted to the separate web page identified by a different URL by traditional online advertising, print advertising and the like. The cross-marketing interface allows consumers 12 to search for products based on descriptions and specifications and the like.

The cross-marketing interface does not undermine the other aspects of the present invention. Instead, the cross-marketing interface is separately advertised as a source for product information on all sorts of products. The consumer 12 is directed to a web site interface on a different domain from the previously discussed web sites, so that there is no confusion or misdirection of consumers 12 away from resellers 24. Consumers 12 who visit the cross-marketing interface are attracted to the site through different means.

As shown in FIG. 7, the cross-marketing interface provides a advantageous marketing opportunity for resellers 24 to attract consumers 12 to their sites. Resellers 24 who sign up for the cross-marketing opportunity will be included in a list of resellers 24 of a product, and the product information system 10 refers consumers 12 to the resellers 24 through the list. Thus, consumers 12 who are looking for a product can visit the product information system 10 through the cross-marketing interface to view product information and clickable list of resellers 24 from which to purchase the product.

As shown in FIG. 7, the consumer 12 may interact with the system 10 through an entirely separate interface for finding products to fill a need. The consumer 12 visits a product search page over the Internet (step 96). The web server 28 displays a product search page (step 98). A consumer 12 enters search request information (step 100) and submits the search request to the web server 28 (step 102). The web server 28 then searches the database 30 for the requested products based on the information provided (step 104). If the web server 28 finds no products satisfying the search request, the web server 28 displays the product search page (step 98) with the message “NO PRODUCTS FOUND IN SEARCH” displayed below the search form.

If the search is successful, the web server 28 determines the catalog or on-line retailers who sell this particular product (step 106). The web server 28 dynamically builds a web page using the product information and the retrieved catalog reseller information (step 108). The web server 28 displays the built web page for the consumer 12 (step 110). The built web page contains the name of the found products and the name of the participating resellers 24 who sell the product.

The consumer 12 views the product information (step 112) and selects a product reseller 24 from the list (step 114). The web server 28 then retrieves the link for the reseller's purchase web page according to the reseller 24 chosen by the consumer 12 (step 116). The web server 28 dynamically refers the consumer 12 to the reseller's purchase page to complete the sale. (step 118). Thus, the product information system 10 refers consumers 12 to the reseller's web site 24a to complete the sale.

The system 10 is capable of organizing the list of resellers 24 for each product into a sorted list, by alphabetical order, by price and so on. Resellers 24, retailers, and wholesalers of products can make use of the product information system 10 as well. Vendors 26 can notify retailers and other resellers 24 of their products that supplemental product information is available through this particular site based on the manufacturer number.

In addition to use with printed catalogs, the product information system 10 may be used in co-op advertising. When retailers run advertising in magazines or newspapers, they often will seek co-op advertising dollars from their resellers 24. By using the product information system 10, and linking the product information system 10 to resellers 24, more co-op dollars can be attracted with the added value provided to the reseller 24.

The product information system 10 offers consumers 12 the opportunity to comparison shop for competitive prices and to search for related products. If the consumer 12 is referred to the product information system 10 from a reseller's web site 24a or a printed catalog 22, the comparison search and related product search are programmatically limited by the product information system 10 to only retrieve and display products sold by the reseller's web site 24a or printed catalog 22. For example, a consumer 12 visits a reseller's web site 24a to browse for a certain type of product. The consumer 12 then clicks on a button that links the consumer 12 to the product information system 10. The product information system 10 displays supplemental product-specific information to the consumer 12. The consumer 12 then clicks on a button to compare prices. The product information system 10 retrieves similar products offered by the same reseller 24a, and displays the similar products in a list with the pricing information. Similarly, if the consumer clicks on a button to see related products, the product information system 10 retrieves related products offered by the same reseller 24a, and displays the similar products in a list. Thus, consumers 12 use the product information system 10 to find the best product for their needs that is offered by the referring reseller 24a.

If the consumer 12 visits the cross-marketing interface of the product information system, the consumer 12 can search for related products and perform price comparisons, and the system 10 does not limit the searches to a referring reseller 24a. Instead, the consumer 12 can use the system 10 to find the best product available that is offered by any participating vendor 26 or reseller 24. Thus, the product information system 10 serves consumers 12 by helping them find the best product at the best price, based on product-specific information stored in the database 30 of the system 10.

The permission-based e-mail feature, described above with respect to on-line retailer 24a referrals, can also be accessed by catalog retailers 24b and store retailers 24c. Each referral source can activate the permission-based e-mail feature to begin building a list of e-mail addresses for use in on-line marketing. In addition, the cross-marketing interface can collect e-mail addresses to deliver broadcast announcements regarding product-specific sales, etc. Thus, the cross-marketing interface can build a list of e-mail subscribers in order to attract consumers 12 to view specific product offerings and then refer the consumer 12 to the reseller 24a to complete the sale. Thus, the product information system 10 provides a cost-effective way for resellers 24 to market their products.

The product information system 10 enhances the reseller's on-line web site 24a by providing supplemental, product-specific information at the click of a button. The consumer 12 has convenient, efficient and fast access to product-specific information at the point-of-purchase, thereby assisting the consumer 12 in making a purchase decision without losing the consumer's attention or losing control of the consumer 12.

The product information system 10 is designed to provide a restricted product information environment, which allows for presentation of available information to a consumer 12 to assist in a buying decision, without interfering with the transaction. Rather than refer consumers 12 to a competing sellers site for information, such as the manufacturer's web site, catalog companies and retailers can refer the consumer 12 to a third-party, non-transactional, product information system 10, which provides information and then returns the consumer 12 to the referring site for completion of the commercial transaction.

Generally, to parse URL search requests and to display pages dynamically, the web server 28 employs scripts. Common Gateway Interface (CGI) scripts, for instance, must be stored in a specific directory on the web server 28. Other scripts may also be employed for both parsing the search requests and building results web pages for display.

In the preferred embodiment, the web server 28 uses scripts to build the web pages for display. The link on the reseller's web site, which links to the product information system 10, can either open a new target window for the product display information or refer the consumer 12 directly. If the reseller 24 opens a new target window, the script builds the page such that all browser buttons are disabled and hidden, leaving the consumer 12 the option to close the window. If the reseller 24 refers the consumer 12 directly, the browser buttons are disabled by the script, with the exception of the “back” button, thereby requiring the consumer to return to the reseller's Internet site. For consumers 12 who visit the site directly, all browser buttons remain active and visible, so that consumers 12 can easily navigate the Internet site.

The product information system 10 receives a request for product information from a clickable link on the reseller's web site. A consumer clicks on the link, and the consumer is routed to another Internet domain (i.e. from www.catalogcompany.com to www.productinfolink.com, and the like) to view the supplemental information. The product information system 10 receives the product information request from a reseller 24, retrieves and displays the product information, and returns the consumer to the reseller's web page.

Although the present invention has been described with reference to preferred embodiments, workers skilled in the art will recognize that changes may be made in form and detail without departing from the spirit and scope of the invention.

1. A method for providing supplemental product-specific information, the method comprising:
accepting an Internet-based product information request initiated by a consumer, the product information request including a unique product identifier and a seller identifier from an seller;
retrieving product information from a database according to the product information request;
displaying dynamically an Internet web page containing the retrieved product information for a consumer; and
returning the consumer to the seller over the Internet to complete the commercial sale.

2. The method of claim 1, the method further comprising:
retrieving seller information from the seller over the Internet;
retrieving seller display information from the database according to the seller information; and
displaying dynamically the seller display information in the Internet web page with the retrieved product information.

3. The method of claim 1, wherein the consumer is returned to the seller using an embedded script based on Internet browser history of the consumer.

4. The method of claim 1, wherein the Internet web page is displayed dynamically within a new browser window and the consumer is returned to the seller Internet site by closing the new browser window.

5. The method of claim 1, wherein accepting the product information request comprises:
executing a script to parse a URL, the URL containing an unique product identifier;
extracting the unique product identifier from the URL using the script.

6. The method of claim 5, wherein the URL contains a source identifier, the source identifier serving as an indication of a referring source, wherein extracting further comprises:
extracting the source identifier from the URL using the script.

7. The method of claim 5, wherein retrieving product information comprises:
searching the database using the unique product identifier.

8. The method of claim 1, wherein the commercial sale is completed by the seller.

9. A system for providing product information comprising:
an Internet web server having a web site interface, the Internet web server capable of displaying multimedia information;
a product database in network communication with the web server, the product database containing a plurality of records, each record corresponding to a commercial product;
a referral database for retrieving information about a referring reseller including a Internet address for the referring reseller; and
a search engine associated with the product database and the referral database, the search engine for retrieving one of the plurality of records according to an unique product identifier and a referral identifier.

10. The system of claim 9, further comprising:
scripts for parsing search requests received over the Internet.

11. The system of claim 10, wherein the scripts parse search requests received from an seller, the search request including the unique product identifier and the referral identifier, and wherein the scripts interact with the search engine to retrieve product information associated with the unique product identifier and referral information associated with the referral identifier.

12. The system of claim 10, the system further comprising:
a web page builder script for receiving the product information and the referral information and for dynamically building a web page according to the received information.

13. A method for providing supplemental product-specific information, the method comprising:
displaying an Internet web page for a consumer to enter a referral identifier and an unique product identifier;
accepting an Internet product information request from the Internet web page;
retrieving product information from a product database according to the product information request;
displaying dynamically a new Internet web page containing the retrieved product information for the consumer; and
linking the consumer to a web site for an seller to complete the sale.

14. The method of claim 13, wherein the referral identifier is associated with a specific business selected from a group consisting of a catalog reseller name, a manufacturer name, and a retailer name.

15. The method of claim 13, wherein the referral identifier is selected using a pull down list.

16. The method of claim 13, wherein retrieving the product information comprises:
extracting the unique product identifier from the Internet product information request using a parser script; and
searching the product database for product information using the unique product identifier.

17. A method for cross-marketing products, the method comprising:
displaying an Internet search page for consumers to enter desired product information;
searching a product database for product information that satisfies the desired product information;
retrieving reseller information associated with each found product; and
displaying an Internet page containing a clickable list of found products.

18. The method of claim 17, wherein a consumer selects an item on the list by clicking on the item in the list, the method further comprising:
displaying a product information page containing information about the found product and a list of clickable reseller links for linking the consumer to a purchase web page for the associated reseller; and
linking programmatically the consumer to the purchase web page for the associated reseller in order to complete the sale.

19. A method for providing a third party Internet site having supplemental product-specific information, wherein a consumer visits a product reseller's web page and clicks on a link to the third party Internet site for supplemental information about a specific product offered on the product reseller's Internet page, the improvement comprising:
embedding a unique product identifier within the link;
transmitting the unique product identifier to the third party Internet site on a different Internet domain based on an action by the consumer;
searching a database on the third-party Internet site according to the unique product identifier;
retrieving from the database supplemental product-specific information associated with the unique product identifier;
displaying programmatically the supplemental product-specific information for the consumer; and
programmatically returning the consumer to the reseller's Internet page for the reseller to complete a product sale.

20. A third party web site, wherein a consumer visits a reseller's web site to view commercially available products, the reseller's web site containing graphical, textual and numeric information concerning commercially available products, wherein the reseller's web site contains links to the third party web site, each link being positioned adjacent to a specific product and being associated with the specific product, the improvement comprising:
embedded information contained in the link, the embedded information including an unique identifier associated with the specific product;
an Internet web server at the third party web site for displaying Internet web pages;
a database server at the third party web site, the database server in network communication with the web server; and
a search engine in network communication with the web server and the database;
wherein on the link transmits the embedded information to the search engine over the Internet, the search engine parses the embedded information to retrieve a unique product identifier, the search engine uses the unique product identifier to retrieve supplemental product-specific information from the database and provide the supplemental product-specific information to the web server for display; and
wherein the web server links the consumer to the reseller's web site to complete a sale transaction.

21. A method for providing one click access to supplemental product specific information, the method comprising:
embedding a unique product identifier within a link on a seller web site; and
retrieving supplemental product-specific information for display from a product information database according to the unique product identifier;
wherein one click on the link retrieves and displays the supplemental product-specific information.
